(19) United States
(12) Patent Application Publication
(10) Pub. No.: US 2026/0138392 A1
(43) Pub. Date: May 21, 2026

(54) AERODYNAMIC WHEEL COVER AND WHEEL

(71) Applicant: HOWMET AEROSPACE INC., Pittsburgh, PA (US)

(72) Inventors: Grant A. DeGeorge, Strongsville, OH (US); Douglas P. Mason, Livonia, MI (US); Logan Klink, Olmsted Township, OH (US); Mateusz KOWALSKI, Parma, OH (US)

(21) Appl. No.: 19/119,490

(22) PCT Filed: Dec. 12, 2023
(86) PCT No.: PCT/US23/83538

§ 371 Date: Apr. 9, 2025

Related U.S. Application Data
(60) Provisional application No. 63/387,402, filed on Dec. 14, 2022.

(51) Int. Cl. B60B 7/00

(52) U.S. Cl. CPC B60B 7/0066; B60B 2320/10; B60B 2900/1216

(57) ABSTRACT

A wheel cover comprises a central portion comprising a planar surface, a first arcuate portion surrounding the central portion and comprising a first arcuate surface having a first radius of curvature, and a second arcuate portion surrounding the first arcuate portion and comprising a second arcuate surface having a second radius of curvature. The second radius of curvature is different than the first radius of curvature. The planar surface, the first arcuate surface, and the second arcuate surface form a continuous and uninterrupted outer surface from a center of the wheel cover to an outermost peripheral edge of the wheel cover.

### CROSS REFERENCE TO RELATED APPLICATIONS

This application is the US national phase of PCT/US2023/83538, which was filed on Dec. 12, 2023 which claims priority to U.S. Provisional Application No. 63/387,402, filed Dec. 14, 2022.

### BACKGROUND

Wheel covers are used on large truck vehicles to reduce possible adverse aerodynamic effects. Aerodynamic wheel covers are useful for reducing wind resistance and improving fuel economies.

### SUMMARY

A wheel cover according to an exemplary aspect of the present disclosure includes, among other things: a central portion comprising a planar surface; a first arcuate portion surrounding the central portion and comprising a first arcuate surface having a first radius of curvature; a second arcuate portion surrounding the first arcuate portion and comprising a second arcuate surface having a second radius of curvature that is different than the first radius of curvature; and wherein the planar surface, the first arcuate surface, and the second arcuate surface form a continuous and uninterrupted outer surface from a center of the wheel cover to an outermost peripheral edge of the wheel cover.

In a further non-limiting embodiment of the foregoing wheel cover, a ratio of the first radius of curvature to the second radius of curvature is in a range from 1 to 2.

In a further non-limiting embodiment of any of the foregoing wheel covers, the ratio is 1.5 or less.

In a further non-limiting embodiment of any of the foregoing wheel covers, the center of the wheel cover defines a reference line, and wherein the planar surface extends perpendicular to the reference line.

In a further non-limiting embodiment of any of the foregoing wheel covers, the first radius of curvature and the second radius of curvature are measured from a location offset from the reference line.

In a further non-limiting embodiment of any of the foregoing wheel covers, the central portion comprises a first percentage of surface area, the first arcuate portion comprises a second percentage of surface area, and the second arcuate portion comprises a third percentage of surface area, and wherein the first percentage of surface area is greater than the second percentage of surface area, and wherein the first percentage of surface area is greater than the third percentage of surface area.

In a further non-limiting embodiment of any of the foregoing wheel covers, the third percentage of surface area is greater than the second percentage of surface area.

A wheel assembly according to another exemplary aspect of the present disclosure includes, among other things: a wheel having a rim configured to support a tire; and a wheel cover positioned to cover a laterally outward facing surface of the wheel, wherein the wheel cover comprises: a central portion comprising a planar surface; a first arcuate portion surrounding the central portion and comprising a first arcuate surface having a first radius of curvature; a second arcuate portion surrounding the first arcuate portion and comprising a second arcuate surface having a second radius of curvature that is different than the first radius of curvature; and wherein the planar surface, the first arcuate surface, and the second arcuate surface form a continuous and uninterrupted outer surface from a center of the wheel cover to an outermost peripheral edge of the wheel cover.

In a further non-limiting embodiment of the foregoing wheel assembly, the outermost peripheral edge of the wheel cover is approximately equal to a diameter of the rim.

In a further non-limiting embodiment of any of the foregoing wheel assemblies, the continuous and uninterrupted outer surface of the wheel cover entirely covers the laterally outward facing surface of the wheel.

In a further non-limiting embodiment of any of the foregoing wheel assemblies, the central portion and at least the first arcuate portion extend laterally outward of an outside edge of the tire.

In a further non-limiting embodiment of any of the foregoing wheel assemblies, the rim includes a standoff that surrounds a lug tower area, and wherein the central portion and at least the first arcuate portion extend laterally inward of the standoff.

In a further non-limiting embodiment of any of the foregoing wheel assemblies, the rim comprises a laterally outermost surface of the wheel.

In a further non-limiting embodiment of any of the foregoing wheel assemblies, the laterally outward facing surface of the wheel comprises an outwardly facing curved surface that extends outwardly of the rim, and wherein the outwardly facing curved surface has a radius of curvature that matches the second radius of curvature.

In a further non-limiting embodiment of any of the foregoing wheel assemblies, an outer edge of the second arcuate portion is received immediately adjacent to an outermost edge of the outwardly facing curved surface such that the outermost peripheral edge of the wheel cover blends into the outwardly facing curved surface.

In a further non-limiting embodiment of any of the foregoing wheel assemblies, the outwardly facing curved surface has a greater arcuate length than an arcuate length of the second arcuate portion.

In a further non-limiting embodiment of any of the foregoing wheel assemblies, an aerodynamic surface collectively established by the continuous and uninterrupted outer surface of the wheel cover and the outwardly facing curved surface of the wheel extends across an entire area within a circumference of the rim of the wheel.

In a further non-limiting embodiment of any of the foregoing wheel assemblies, the wheel cover includes one or more of: a ratio of the first radius of curvature to the second radius of curvature is in a range from 1 to 2; the center of the wheel cover defines a reference line, and wherein the planar surface extends perpendicular to the reference line, and wherein the first radius of curvature and the second radius of curvature are measured from a location offset from the reference line; the central portion comprises a first percentage of surface area, the first arcuate portion comprises a second percentage of surface area, and the second arcuate portion comprises a third percentage of surface area, and wherein the first percentage of surface area is greater than the second percentage of surface area, and wherein the first percentage of surface area is greater than the third percentage of surface area, and wherein the third percentage of surface area is greater than the second percentage of surface area.

A method according to another exemplary aspect of the present disclosure includes, among other things: supporting a tire on a rim of a wheel; forming a wheel cover to include: a central portion comprising a planar surface; a first arcuate portion surrounding the central portion and comprising a first arcuate surface having a first radius of curvature; a second arcuate portion surrounding the first arcuate portion and comprising a second arcuate surface having a second radius of curvature that is different than the first radius of curvature; and wherein the planar surface, the first arcuate surface, and the second arcuate surface form a continuous and uninterrupted outer surface from a center of the wheel cover to an outermost peripheral edge of the wheel cover; and mounting the wheel cover to the wheel to provide a continuous and uninterrupted aerodynamic surface from the wheel cover to the wheel.

In a further non-limiting embodiment of the foregoing method, the method includes forming the rim as a laterally outermost surface of the wheel, and covering an entire area within a circumference of the rim of the wheel with the wheel cover to provide the continuous and uninterrupted aerodynamic surface; or forming a laterally outward facing surface of the wheel to include an outwardly facing curved surface that extends outwardly of the rim, wherein the outwardly facing curved surface has a radius of curvature that matches the second radius of curvature, and positioning an outer edge of the second arcuate portion immediately adjacent to an outermost edge of the outwardly facing curved surface such that the outermost peripheral edge of the wheel cover blends into the outwardly facing curved surface to provide the continuous and uninterrupted aerodynamic surface.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 is a perspective view of an aerodynamic wheel cover designed according to an example embodiment.

FIG. 2 is an elevational view of the wheel cover shown in FIG. 1.

FIG. 3 is a cross-sectional view taken along the lines 3-3 in FIG. 2.

FIG. 4 is a cross-sectional view similar to FIG. 3 showing the wheel cover situated on a wheel.

FIG. 5 is a cross-sectional view of another example embodiment in which the wheel establishes an outer portion of the aerodynamic surface.

FIG. 6 is a cross-sectional view showing a known wheel configuration compared to the configuration of the wheel also shown in FIG. 5.

### DETAILED DESCRIPTION

Aerodynamic wheel covers having features like those of the disclosed embodiments are useful for reducing wind resistance and improving fuel economies. The disclosed examples are particularly useful on large truck vehicles and are described as such for discussion purposes. The aerodynamic performance of the disclosed example embodiments and others like them may be beneficial when used on other types of vehicles.

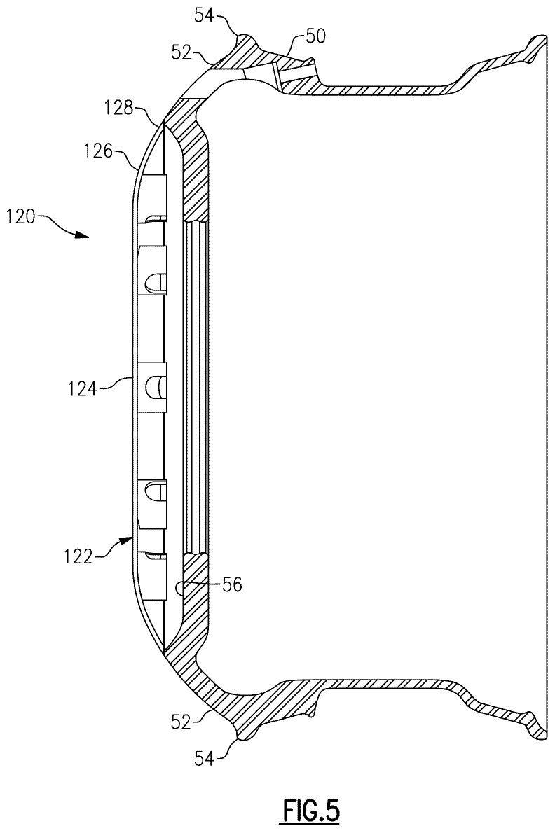

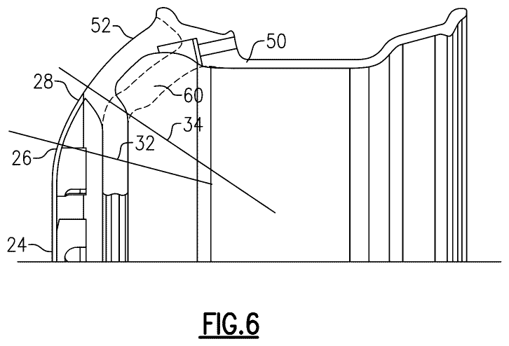

FIGS. 1-4 show one example of an aerodynamic wheel cover 20 and FIGS. 5-6 show another example of an aerodynamic wheel cover 120. An outer surface 22, 122 of the wheel cover 20, 120 is smooth, continuous, and uninterrupted. In some embodiments, the only interruption in the outer surface 22, 122 is an opening for tire valve access. The outer surface 22 includes a central portion 24, a first arcuate portion 26 surrounding the central portion 24, and a second arcuate portion 28 surrounding the first arcuate portion 26.

The central portion 24 of the outer surface 22 is flat or planar. The central portion 24 of the outer surface is oriented perpendicular to a reference line 30 extending through a center of the wheel cover 20, which corresponds to an axis of a corresponding wheel when the wheel cover 20 is situated on a wheel. The first arcuate portion 26 is curved and has a first radius of curvature represented at 32. The second arcuate portion 28 has a second, different radius of curvature represented at 34. The radii of curvature are measured from a location offset from the reference line 30 and the central portion 24 of the outer surface 22.

A ratio of the first radius of curvature to the second radius of curvature is in a range from 1 to 2. In some embodiments, the ratio is approximately 1.5. In the illustrated example embodiment, the first radius of curvature is 7.5 inches, the second radius of curvature is 5.3 inches, and the ratio of the first radius of curvature to the second radius of curvature is approximately 1.4.

The dimensions of the example embodiment include an outer diameter of approximately 23 inches. The central portion 24 in this example embodiment has a diameter of approximately 12 inches and occupies approximately 45% of the surface area of the outer surface 22. The central portion diameter may be in a range that allows the central portion 24 to overlap a majority of the area occupied by the lug towers of the wheel onto which the cover 20 will be installed. For example, the central portion 24 may have a diameter in a range from 11 to 16 inches. The diameter of the central portion 24 is at least large enough to extend over the lug towers of the wheel without extending radially outward too far such that the incline of the arcuate portions 26 and 28 becomes too steep that the aerodynamic performance of the cover 20 is compromised.

The first arcuate portion 26 occupies approximately 20% of the surface area of the outer surface 22. The second arcuate portion 28 occupies approximately 35% of the surface area of the outer surface 22.

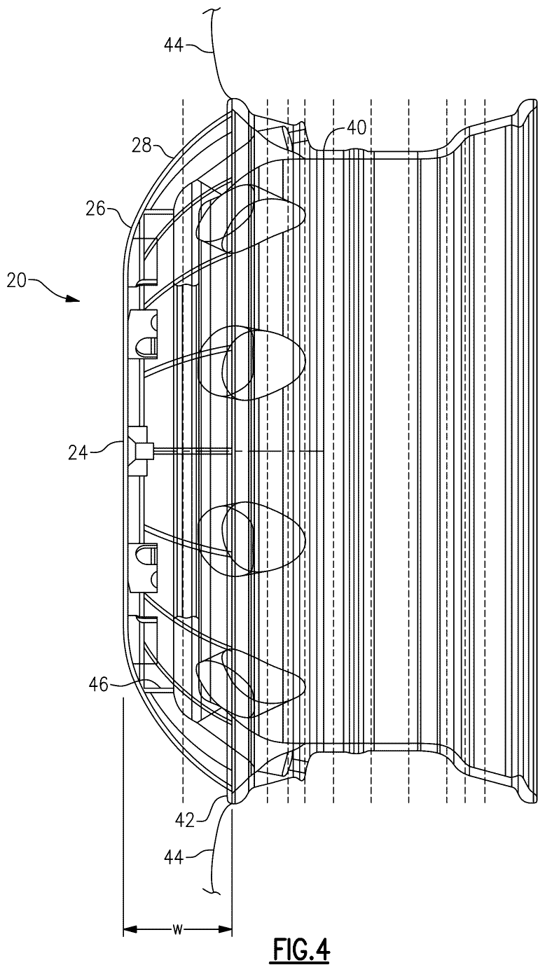

FIG. 4 shows the wheel cover 20 situated on a wheel 40. The outer diameter of the wheel cover 20 (e.g., 23 inches) is approximately equal to a diameter of a rim 42 of the wheel. The outer surface 22 of the wheel cover 20, therefore, establishes the entire laterally outward facing surface within the space occupied by the wheel 40.

The profile of the outer surface 22 provides aerodynamic advantages compared to previous wheel covers. The configuration of the outer surface 22 establishes airflow in the vicinity of the tire 44 that reduces drag or wind resistance. The beneficial airflow dynamics contribute to reducing fuel consumption.

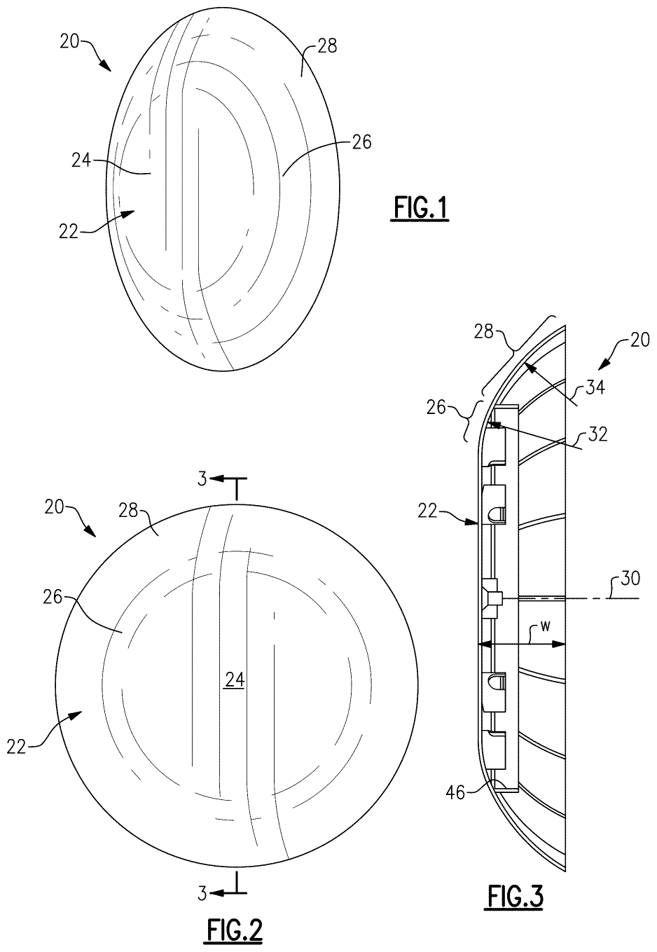

The central portion 24 and at least the first arcuate portion 26 are situated beyond the lateral outside edge of a tire 44 supported on the wheel 40. The lateral location of the central portion 24 is sufficiently far out enough relative to the wheel 40 to fit over the lug towers (not illustrated). In an example embodiment, an overall width W (e.g., from right to left in FIG. 3) is approximately 3.5 inches. The length of a standoff 46, which surrounds the area occupied by the lug towers is approximately 1.5 inches.

FIG. 5 shows another example embodiment of a wheel cover 120. In this example, the wheel cover 120 is comprised as a single-piece; however, the wheel cover 120 could also be comprised of multiple pieces. As shown in FIG. 5, in this example the wheel cover 120 is situated on a wheel 50 that has an outwardly facing curved surface 52 that has the same radius of curvature as a second arcuate portion 128, which is the same as the second radius of curvature of the second arcuate portion 28 of the wheel cover 20 described above. The outer edge of the second arcuate portion 128 in this embodiment is received immediately adjacent the outwardly facing curved surface 52 such that the curved surface 52 establishes part of the aerodynamic surface that reduces wind resistance or drag. In other words, the second arcuate portion 128 of the wheel cover 120 and the curved portion 52 equate to the second arcuate portion of the wheel cover 20 described above.

In this example embodiment, the curved surface 52 has an arcuate length that is greater than the arcuate length of the second arcuate portion 128 on the cover 120. The curved surface 52 extends from the rim 54 of the wheel 50 to the interface with the outer edge of the cover 120. The arcuate length of the curved surface is sufficient to at least occupy the space between the rim 54 and a plane that includes the front face mounting surface 56 of the wheel 50. In the illustrated example embodiment, the curved surface 52 extends further radially inward beyond the minimum required arcuate length.

The aerodynamic surface collectively established by the outer surface 122 of the wheel cover 120 and the curved surface 52 of the wheel 50 extends across the entire area within the circumference of the rim 54 of the wheel 50.

FIG. 6 includes broken lines showing a section of a known wheel configuration at 60. Comparing the wheel 50 to such a known wheel, one can see that the curved surface 52 extends laterally outward further than the corresponding section shown at 60 in broken lines. The aerodynamic features of the wheel cover 120 and the wheel 50 reduce drag significantly. Further, the design of wheel 50 allows aerodynamic benefits that achieve fuel savings which would not be expected by an increase in mass of the a wheel.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A wheel cover comprising:
a central portion comprising a planar surface;
a first arcuate portion surrounding the central portion and comprising a first arcuate surface having a first radius of curvature;
a second arcuate portion surrounding the first arcuate portion and comprising a second arcuate surface having a second radius of curvature that is different than the first radius of curvature; and
wherein the planar surface, the first arcuate surface, and the second arcuate surface form a continuous and uninterrupted outer surface from a center of the wheel cover to an outermost peripheral edge of the wheel cover.

2. The wheel cover of claim 1, wherein a ratio of the first radius of curvature to the second radius of curvature is in a range from 1 to 2.

3. The wheel cover of claim 2, wherein the ratio is 1.5 or less.

4. The wheel cover of claim 1, wherein the center of the wheel cover defines a reference line, and wherein the planar surface extends perpendicular to the reference line.

5. The wheel cover of claim 4, wherein the first radius of curvature and the second radius of curvature are measured from a location offset from the reference line.

6. The wheel cover of claim 1, wherein the central portion comprises a first percentage of surface area, the first arcuate portion comprises a second percentage of surface area, and the second arcuate portion comprises a third percentage of surface area, and wherein the first percentage of surface area is greater than the second percentage of surface area, and wherein the first percentage of surface area is greater than the third percentage of surface area.

7. The wheel cover of claim 6, wherein the third percentage of surface area is greater than the second percentage of surface area.

8. A wheel assembly comprising:
a wheel having a rim configured to support a tire; and
a wheel cover positioned to cover a laterally outward facing surface of the wheel, wherein the wheel cover comprises:
a central portion comprising a planar surface;
a first arcuate portion surrounding the central portion and comprising a first arcuate surface having a first radius of curvature;
a second arcuate portion surrounding the first arcuate portion and comprising a second arcuate surface having a second radius of curvature that is different than the first radius of curvature; and
wherein the planar surface, the first arcuate surface, and the second arcuate surface form a continuous and uninterrupted outer surface from a center of the wheel cover to an outermost peripheral edge of the wheel cover.

9. The wheel assembly of claim 8, wherein the outermost peripheral edge of the wheel cover is approximately equal to a diameter of the rim.

10. The wheel assembly of claim 8, wherein the continuous and uninterrupted outer surface of the wheel cover entirely covers the laterally outward facing surface of the wheel.

11. The wheel assembly of claim 8, wherein the central portion and at least the first arcuate portion extend laterally outward of an outside edge of the tire.

12. The wheel assembly of claim 8, wherein the rim includes a standoff that surrounds a lug tower area, and wherein the central portion and at least the first arcuate portion extend laterally inward of the standoff.

13. The wheel assembly of claim 8, wherein the rim comprises a laterally outermost surface of the wheel.

14. The wheel assembly of claim 8, wherein the laterally outward facing surface of the wheel comprises an outwardly facing curved surface that extends outwardly of the rim, and wherein the outwardly facing curved surface has a radius of curvature that matches the second radius of curvature.

15. The wheel assembly of claim 14, wherein an outer edge of the second arcuate portion is received immediately adjacent to an outermost edge of the outwardly facing curved surface such that the outermost peripheral edge of the wheel cover blends into the outwardly facing curved surface.

16. The wheel assembly of claim 14, wherein the outwardly facing curved surface has a greater arcuate length than an arcuate length of the second arcuate portion.

17. The wheel assembly of claim 14, wherein an aerodynamic surface collectively established by the continuous and uninterrupted outer surface of the wheel cover and the outwardly facing curved surface of the wheel extends across an entire area within a circumference of the rim of the wheel.

18. The wheel assembly of claim 8, wherein the wheel cover includes one or more of:
a ratio of the first radius of curvature to the second radius of curvature is in a range from 1 to 2;
the center of the wheel cover defines a reference line, and wherein the planar surface extends perpendicular to the reference line, and wherein the first radius of curvature and the second radius of curvature are measured from a location offset from the reference line;
the central portion comprises a first percentage of surface area, the first arcuate portion comprises a second percentage of surface area, and the second arcuate portion comprises a third percentage of surface area, and wherein the first percentage of surface area is greater than the second percentage of surface area, and wherein the first percentage of surface area is greater than the third percentage of surface area, and wherein the third percentage of surface area is greater than the second percentage of surface area.

19. A method comprising:
supporting a tire on a rim of a wheel;
forming a wheel cover to include:
a central portion comprising a planar surface;
a first arcuate portion surrounding the central portion and comprising a first arcuate surface having a first radius of curvature;
a second arcuate portion surrounding the first arcuate portion and comprising a second arcuate surface having a second radius of curvature that is different than the first radius of curvature; and
wherein the planar surface, the first arcuate surface, and the second arcuate surface form a continuous and uninterrupted outer surface from a center of the wheel cover to an outermost peripheral edge of the wheel cover; and
mounting the wheel cover to the wheel to provide a continuous and uninterrupted aerodynamic surface from the wheel cover to the wheel.

20. The method of claim 19, including:
forming the rim as a laterally outermost surface of the wheel, and covering an entire area within a circumference of the rim of the wheel with the wheel cover to provide the continuous and uninterrupted aerodynamic surface; or
forming a laterally outward facing surface of the wheel to include an outwardly facing curved surface that extends outwardly of the rim, wherein the outwardly facing curved surface has a radius of curvature that matches the second radius of curvature, and positioning an outer edge of the second arcuate portion immediately adjacent to an outermost edge of the outwardly facing curved surface such that the outermost peripheral edge of the wheel cover blends into the outwardly facing curved surface to provide the continuous and uninterrupted aerodynamic surface.
